(19) United States
(12) Patent Application Publication
(10) Pub. No.: US 2021/0319526 A1
(43) Pub. Date: Oct. 14, 2021

(54) SYSTEM AND METHOD FOR TIME STAMPING AND TRANSFERRING INTELLECTUAL PROPERTY RIGHT

(71) Applicant: TECTONIC TECHNOLOGY INNOVATION COMPANY LIMITED, Hong Kong (HK)

(72) Inventors: Ka Leung AU, Hong Kong (HK); Yue CHENG, Hong Kong (HK); Fung LAM, Hong Kong (HK)

(21) Appl. No.: 17/225,341

(22) Filed: Apr. 8, 2021

(30) Foreign Application Priority Data
Apr. 9, 2020 (HK) 32020005574.9

(51) Int. Cl. G06Q 50/18; G06Q 40/04

(52) U.S. Cl. CPC G06Q 50/184; G06Q 40/04; G06Q 50/188

(57) ABSTRACT

Disclosed is a computer implemented method for time stamping and transferring intellectual property right, including the following steps: enrolling plurality of corresponding nodes to a platform; wherein the corresponding nodes include administration node, a public node, super node, child node, independent individual professor node and a service node; uploading information and document of the intellectual property right to the platform by independent individual professor node, super node or child node; wherein the information and document upon uploaded to the platform is time stamped; searching relevant intellectual property right on the platform; negotiating on the platform; composing a customized digital agreement on the platform by selecting, amending and/or adding on a relevant module clause; wherein the customized digital agreement has smart contract functions for automating execution; signing the agreement digitally by corresponding parties; blocking the intellectual property right automatically for further selling; and completing the trade information transaction upon full payment.

### BACKGROUND OF THE INVENTION

### 1. Field of the Invention

This invention relates to an intellectual property right, more particularly relates to a system and method for time stamping and transferring intellectual property rights over computer system networks.

### 2. Description of Related Art Including Information Disclosed Under 37 CFR 1.97 and 37 CFR 1.98

Intellectual property refers to creations of the mind wherein inventions, literary and artistic works, symbols, names and images used in commerce. The intellectual property rights allow creators or owners of patents, trademarks, copyrighted works to benefit from their own work or investment in a creation. Therefore, intellectual property protection turns innovative ideas, creative designs, and other intangible assets into valuable business assets that may contribute significantly to enhance a company's overall position in the market. In several key technology areas, some enterprises have begun to appreciate that their intellectual property assets are often even more valuable than their physical assets. Hence, if said intellectual property assets are valuable business assets, the protection of intellectual property could be considered as an investment.

Some intellectual property does not need registration of ownership, such as copyrights in Hong Kong. The proof of the original creation of the original artwork is necessary from time to time. Generally, all forms of intellectual property are transferable, either temporarily transferred under a license or permanently transferred by assignment. However, the process of transferring said intellectual property right may involve complicated steps, time and cost. This is because an official legal contract is needed to be composed and reviewed by lawyers, which is costly and time consuming.

Several approaches in providing an open market for transferring intellectual property rights digitally and electronically while preserving all the associated intellectual property rights have been disclosed in the prior arts. For example, U.S. Pat. No. 8,799,175 B2 has disclosed a method of operating a computerized marketplace system. The website of the invention interacts with two classes of parties: vendors who are patent owners who wish to sell patent licenses; customers who are companies that may have present or future liability for infringing the vendor's patent(s), and may wish to purchase a patent license from the vendor. Through the website, customers can purchase paid-up, lump-sum licenses from the vendors. The website employs standard forms that ensure no hassles, no haggling, no strings and no worries. However, the whole transaction of said computerized marketplace system is only involving in between vendor and customer. As such, there will be no service provider such as legal advisor to assist in the system to compose a comprehensive legal agreement to avoid litigation in future. The disclosed invention provides standard licensing contract which does not facilitate the composition of the agreement if any negotiation between the buyer and the seller occurs.

United States Patent Application Publication No. 20160371803 has disclosed a method of aggregating and valuing intellectual property in a financial exchange. The invention provides means whereby holders of intellectual property rights may sell or license intellectual property to an aggregator and receive shares of stock or cash for the contribution based on the aggregated value of the intellectual property held by the aggregator. The method is more particularly to create a publicly traded security in an intellectual property aggregator. However, the method for aggregating intellectual property comprising the step of transferring-in a plurality of intellectual property rights from a holder to an aggregator; and transferring-out the intellectual property rights to one or more acquirers. This method may require complicated transactions because the transfer-in must be completed by selling or licensing to the aggregator.

United States Patent Application Publication No. 20090024513 A1 disclosed a method for transacting intellectual property includes the steps of licensing an IP right corresponding to an IP asset to a licensee according to an agreement; receiving a payment from the licensee for the IP right according to terms of the agreement; and if a call or put option provision in the agreement is exercised, then receiving payment of the strike price and transferring ownership of the IP asset to the licensee. The call option provision provides the licensee the right to purchase the IP asset at a predetermined strike price within a specified time period. The put option provision provides the IP owner a right to sell the IP asset at a predetermined strike price. However, this transaction method may not provide strong legal evidence due to lack of signatory from respective parties.

According to existing prior arts, there is a need to have an improved and customized digital agreement for transferring intellectual property right, which is simple, easy to use and thus able to have effective method of transferring intellectual property right.

### BRIEF SUMMARY OF THE INVENTION

It is an objective of the present invention to provide an open market for time stamping and transferring intellectual property right through a customized digital agreement efficiently.

It is also an objective of the present invention to provide a simple and easy method to time stamp and transfer intellectual property right with a distributed manner and immutable records.

Accordingly, these objectives may be achieved by following the teachings of the present invention. The present invention relates to a computer implemented method for time stamping and transferring intellectual property right, characterized in that enrolling plurality of corresponding nodes to a platform; wherein the corresponding nodes comprises administration node, public node, super node, child node, independent individual professor node and service node; uploading information and document of the corresponding intellectual property right to the platform by independent individual professor node, super node or child node; wherein time stamping the information and document upon uploaded to the platform; searching relevant intellectual property right on the platform; negotiating on the platform; composing a customized digital agreement on the platform by selecting, amending and/or adding on a relevant module clause; wherein the customized digital agreement comprises smart contract functions for automating execution; signing the agreed agreement digitally by respective corresponding parties; blocking the target intellectual property right automatically for further selling; and completing the trade information transaction upon receiving full payment.

### BRIEF DESCRIPTION OF THE SEVERAL VIEWS OF THE DRAWINGS

The features of the invention will be more readily understood and appreciated from the following detailed description when read in conjunction with the accompanying drawings of the preferred embodiment of the present invention, in which:

FIG. 1 shows a diagram of the system to transfer intellectual property rights of the present invention.

FIG. 2 shows a flowchart of agreement between buyer and seller with offline payment.

FIG. 3 shows a flowchart of agreement between buyer and seller with online payment.

FIG. 4 shows a flowchart of agreement between buyer and seller with token payment.

FIG. 5 shows a flowchart of agreement between service provider and client of buyer or seller with offline payment.

FIG. 6 shows a flowchart of agreement between service provider and client of buyer or seller with online payment.

FIG. 7 shows a flowchart of agreement between service provider and client of buyer or seller with token payment.

FIG. 8 shows a diagram of time stamp and provide hash ID for uploading information and/or document.

FIG. 9 shows a diagram of time stamp and provide hash ID for communicating content on the platform.

FIG. 10 shows a diagram of the system to transfer intellectual property right from one intellectual property holder to one buyer.

FIG. 11 shows a diagram of the system to transfer intellectual property right from one intellectual property holder to multiple buyers.

FIG. 12 shows a diagram of the system to transfer intellectual property right from multiple intellectual property holders to one buyer.

FIG. 13 shows a diagram of the system to transfer intellectual property right from multiple intellectual property holders to multiple buyers.

FIG. 14 shows a customized digital agreement.

FIG. 15 shows a diagram example of customized digital agreement.

### DETAILED DESCRIPTION OF THE INVENTION

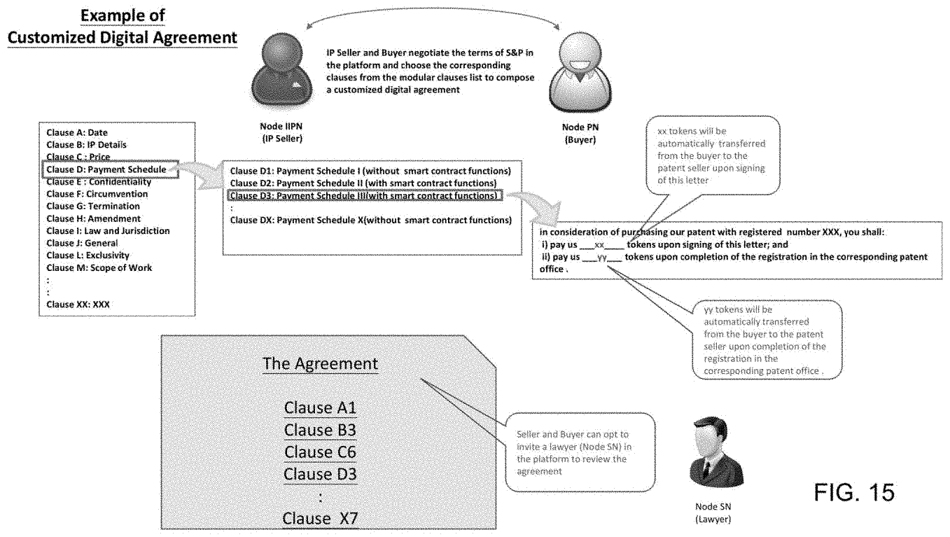

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for claims. It should be understood that the drawings and detailed description thereto are not intended to limit the invention to the particular form disclosed, but on the contrary, the invention is to cover all modifications, equivalents and alternatives falling within the scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned. Where the abbreviations or technical terms are used, these indicate the commonly accepted meanings as known in the technical field. The present invention will now be described with reference to FIG. 15.

The present invention presents a computer implemented method for time stamping and transferring intellectual property right, characterized in that: enrolling plurality of corresponding nodes 100 to a platform 101; wherein the corresponding nodes 100 comprises administration node 100a, public node 100b, super node 100c, child node 100d, independent individual professor node 100e and service node 100f; uploading information and document of the corresponding intellectual property right to the platform 101 by independent individual professor node 100e, super node 100c or child node 100d; wherein time stamping the information and document upon uploaded to the platform 101; searching relevant intellectual property right on the platform 101; negotiating on the platform 101; composing a customized digital agreement 102 on the platform 101 by selecting, amending and/or adding on a relevant module clause; wherein the customized digital agreement 102 comprises smart contract functions for automating execution; signing 103 the agreed agreement digitally by respective corresponding parties; blocking 104 the target intellectual property right automatically for further selling; and completing 105 the trade information transaction upon receiving full payment.

In a preferred embodiment of the present invention, the intellectual property right comprises a patent, a trademark, a trade secret, an industrial design, a copyright and a geographical indication.

In a preferred embodiment of the present invention, the administration node 100a comprises an administrator, public node 100b comprises a buyer, super node 100c comprises a university and research institute, service node 100f comprises a service provider 106, child node 100d and independent individual professor node 100e comprises an inventor.

In a preferred embodiment of the present invention, the content of the uploaded information, document and negotiation that involve any communications by nodes 100 is stored in a distributed file system based on hash table mapping approach. Each piece of stored information in the distributed ledger comprises a hash ID. The hash ID can then be used to represent the real content to be mentioned in the transactions later recorded in the distributed ledger. Everyone can easily verify the real content with a hash ID. Said information and document include but not limited to writing, audio and video.

In a preferred embodiment of the present invention, the module clause comprises plurality of selection for respective parties to select, amend and/or add.

In a preferred embodiment of the present invention, the respective parties are optional to engage a service provider 106 for providing services including but not limited to marketing the patent, legal advices, valuation and writing descriptions. The service provider 106 includes but not limited to legal advisors, intellectual property valuers, writers, promoters, marketers, intellectual property agents, and other intellectual property services providers. Therefore, the platform 101 may comprise intellectual property sellers, buyers and service providers 106.

In a preferred embodiment of the present invention, the signing 103 of a customized digital agreement 102 comprises a one intellectual property holder with one buyer, a one intellectual property holder with multiple buyers, a multiple intellectual property holders with one buyer, a multiple intellectual property holders with multiple buyers, a service provider 106 with client or buyer or seller and in between the service providers 106. The platform 101 offers all the corresponding parties to use respective private key to do the digital signature on the customized digital agreement 102 to serve as a legal proof evidence upon infringements and disputes of intellectual property right occurs.

In a preferred embodiment of the present invention, the smart contract functions trigger fund transfer or other actions automatically after signage of the agreed customized digital agreement 102. Said the other actions comprise an issue of call option for another intellectual property rights, executing another digital agreement 102 and the like.

In a preferred embodiment of the present invention, the trade information transaction is the change of intellectual property ownership. The platform 101 in the present invention could link to the corresponding intellectual property offices for the registration of the change. The completion 105 of said trade information transaction depends on the necessity of registration in the corresponding intellectual property office.

In a preferred embodiment of the present invention, the payment comprises an offline payment, an online payment and a token payment.

The present invention presents a system of customized digital agreement for intellectual property time stamp and right transfer, comprising: means for selecting, amending and/or adding on a relevant module clause; and means for automating execution using smart contract functions.

Below is the example of the system and method for transferring intellectual property right, from which the advantages of the present invention may be more readily understood. It is to be understood that the following examples are for illustrative purpose only and should not be construed to limit the present invention in any way.

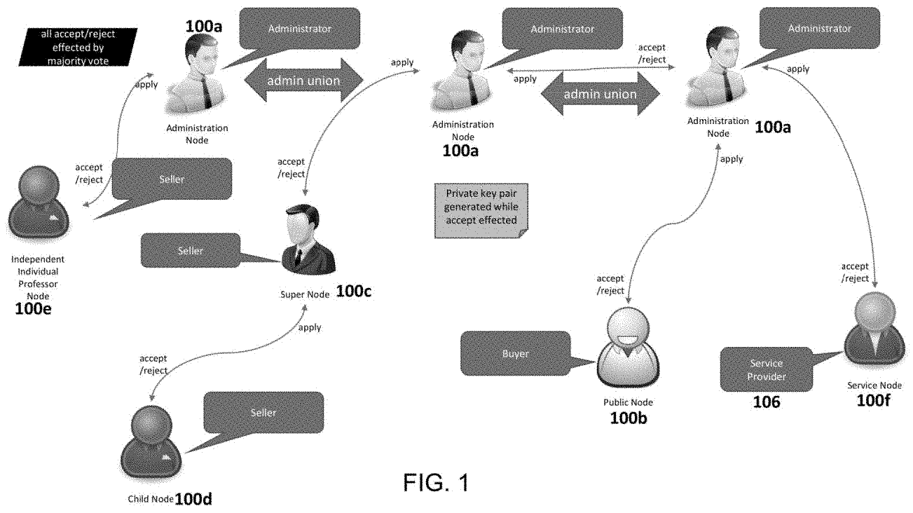

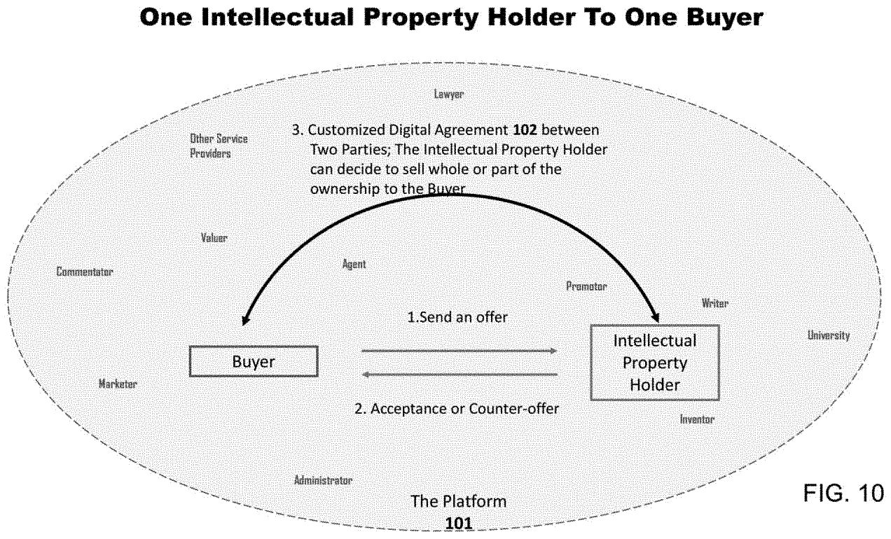

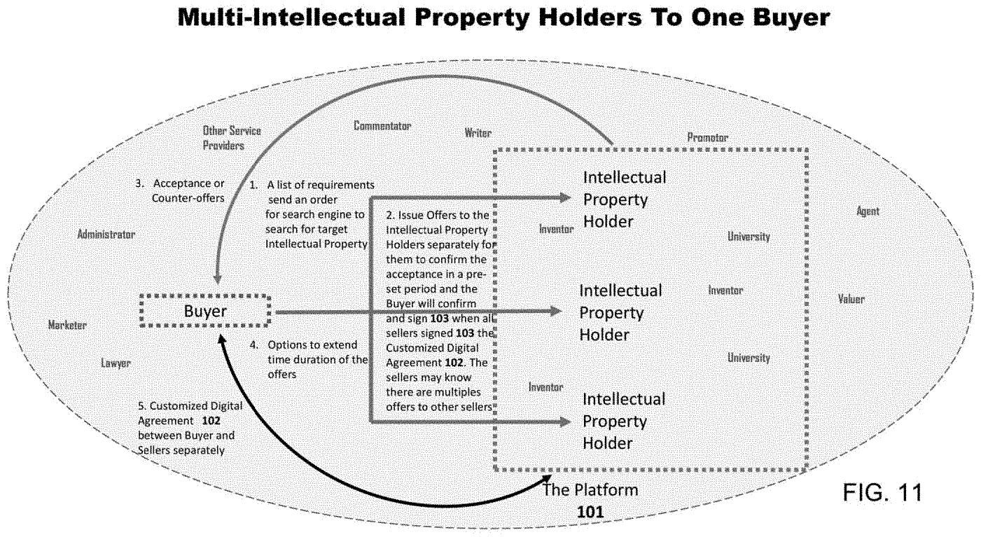

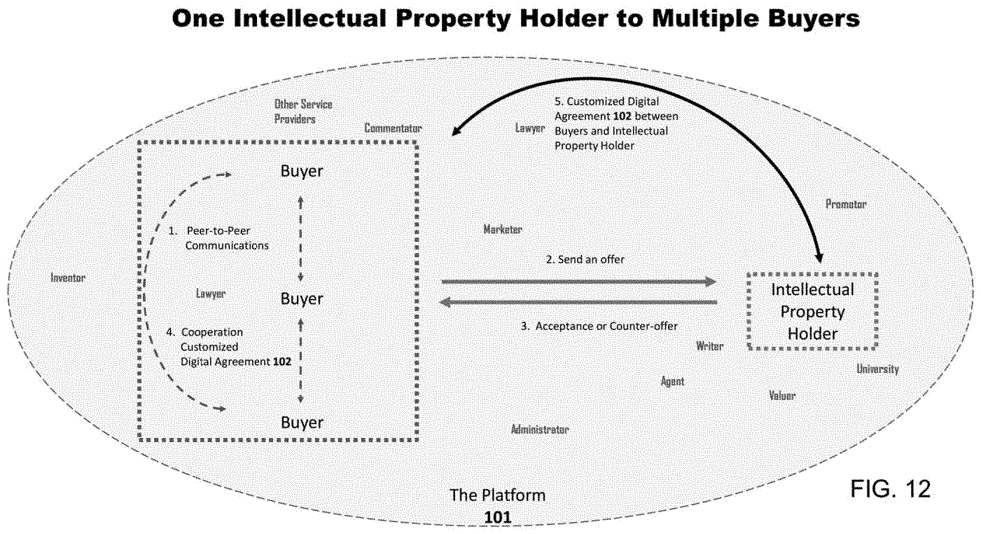

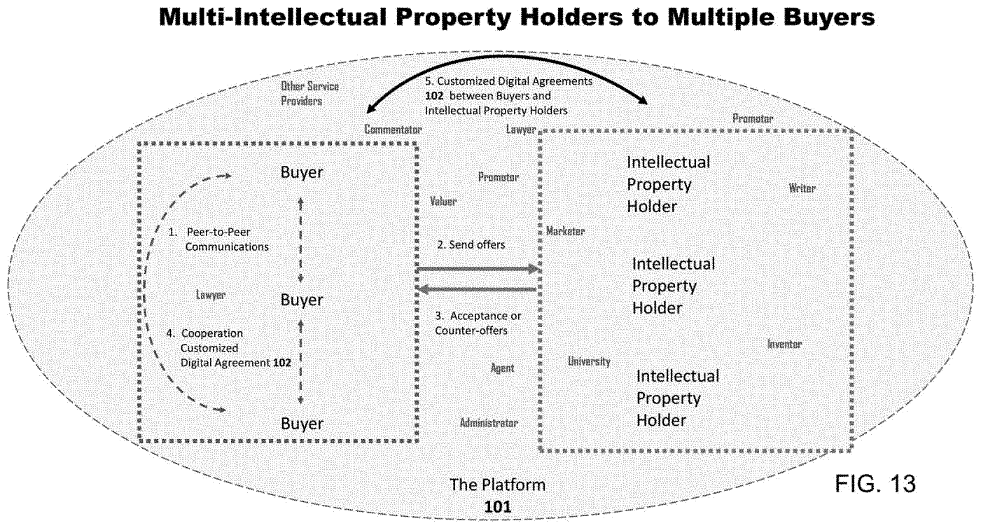

A diagram of the system to transfer intellectual property right is shown in FIG. 1. Referring to FIG. 1, the administration node 100a is connected to the sellers comprises independent individual professor node 100e, super node 100c and child node 100d. Also, the administration node 100a is further connected to the buyers comprises public node 100b and service node 100f. According to FIG. 1, the four types of nodes, which independent individual professor node 100e, super node 100c, child node 100d and the public node 100b, are defined for an intellectual property transfer. The administration node 100a coordinates the intellectual property transfer. The transfer of intellectual property comprises a one intellectual property holder with one buyer, a one intellectual property holder with multiple buyers, a multiple intellectual property holders with one buyer and a multiple intellectual property holders with multiple buyers. A diagram of the system to transfer of intellectual property right from one intellectual property holder to one buyer is shown in FIG. 10. One intellectual property buyer could send an offer to one intellectual property holder. One intellectual property holder could accept the offer by the intellectual property buyer or send counteroffer to the intellectual property buyer. Both the intellectual property buyer and the intellectual property holder could build a customized digital agreement 102. The intellectual property holder could decide to sell the whole or part of the ownership to the intellectual property buyer. According to FIG. 11, a diagram of the system to transfer of intellectual property right from a multiple intellectual property holders to one buyer is shown. The buyer sends requirements to the search engine for searching target intellectual properties, then sends offers to multiple intellectual property holders separately. The multiple intellectual property holders could accept the offer or send counteroffer to the buyer. The buyer would confirm and sign the customized digital agreement 102 when every intellectual property holder signed the customized digital agreement 102. The intellectual property holders may know multiple offers sent to other intellectual property holders. The buyer could optionally extend the time duration of the offers. In FIG. 12, a diagram of the system to transfer intellectual property from one intellectual property holder with multiple buyers is shown. Multiple buyers establish peer-to-peer communications and send offer to the intellectual property holder. The intellectual property holder accepts the offer or sends counteroffer to the multiple intellectual property buyers. Multiple intellectual property buyers cooperatively build a customized digital agreement 102. Both parties signed the customized digital agreement 102. The multiple buyers could share distribution of the proceeds upon disposal or economic benefits. In FIG. 13, a diagram of the system to transfer intellectual property from multiple intellectual property holders with multiple buyers is shown. Multiple buyers establish peer-to-peer communications and send offer to the multiple intellectual property holders separately. The multiple intellectual property holders could accept the offer or send counteroffer to the multiple intellectual property buyers. Multiple intellectual property buyers cooperatively build a customized digital agreement 102. Both parties signed the customized digital agreement 102.

The platform 101 works with intellectual property lawyers to compose common modules of customized digital agreement 102 which are often to be used on an intellectual property transaction. The common modules are optional to be customized by the corresponding parties based on their needs and fill in parameters such as date, price, legal term duration and etcetera. Said corresponding parties can choose the common modules from a module library by selecting, amending and/or adding to build a legal contract by themselves. A customized digital agreement 102 is formulated based on the common modules selected. Any party can build a customized digital agreement 102 from the module library and propose to other parties. A digital signature is required for confirmation upon agree of the customized digital agreement 102. The target intellectual property will be automatically blocked for further selling by the seller. The transaction is completed 105 upon receiving full payment and change of ownership. The completion 105 of change ownership depends on the necessity of registration to the corresponding intellectual property office.

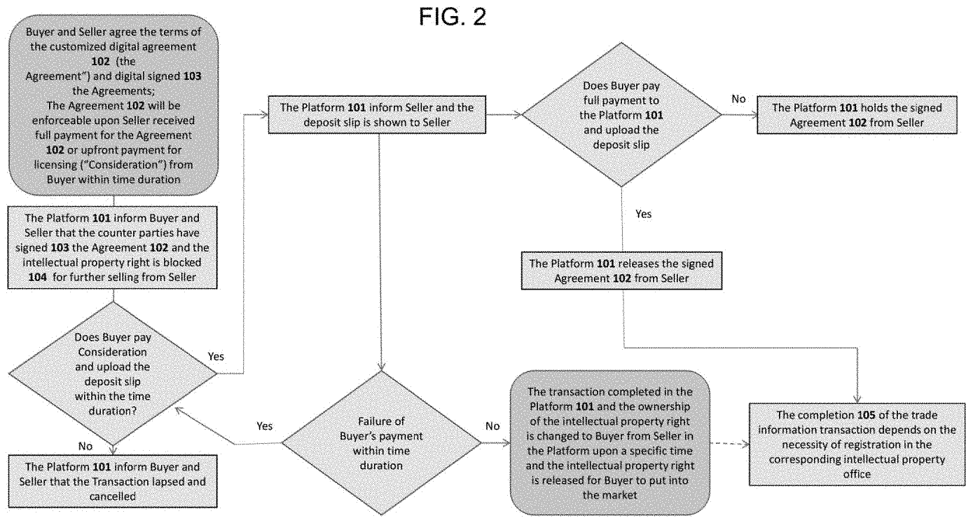

An agreement between buyer and seller with offline payment is shown in FIG. 2. The customized digital agreement 102 between the buyer and seller is uploaded on the platform 101 in a distributed ledger in accordance with the terms of sales and purchase agreement. Every corresponding parties could view the same customized digital agreement 102 whereby the buyer and seller can negotiate the terms in the customized digital agreement 102 via on line or offline. The platform 101 will automaticaúhly block the target intellectual property right for further selling once both buyer and seller digitally signed 103 the customized digital agreement 102 and uploaded to the platform 101 in the distributed ledger. The blocking 104 duration for further selling can be determined case by case. The buyer is required to complete the payment and upload the proof of payment to the distributed ledger within the blocking 104 duration to complete 105 the transaction. The transaction will be cancelled if the buyer fails to complete payment within the blocking 104 duration. The platform 101 will change the ownership of the intellectual property right from the seller to the buyer upon payment confirmation. Hence, the intellectual property right is released for buyer to put into the market. The whole process in this distributed ledger is witnessed by all the corresponding parties. The completion 105 of the trade information transaction depends on the necessity of registration in the corresponding intellectual property office.

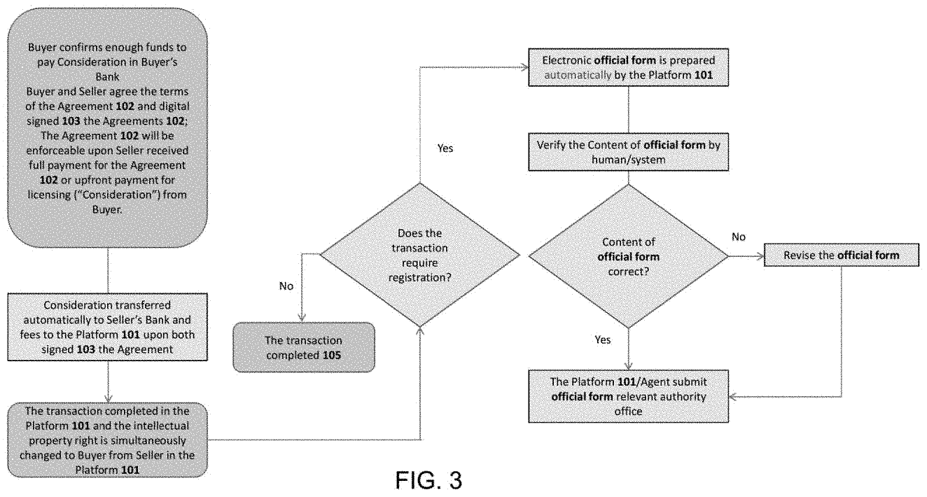

Referring to FIG. 3, an agreement between buyer and seller with on line payment is shown. The customized digital agreement 102 between buyer and seller is uploaded in the distributed ledger in accordance with the terms of sales and purchases or license agreement. Every corresponding parties could view the same customized digital agreement 102 whereby the buyer and seller can negotiate the terms in the customized digital agreement 102 via online or offline. The buyer's bank will transfer the consideration to seller's bank simultaneously once both buyer and seller digitally sign 103 the customized digital agreement 102 and uploaded to the platform 101 in the distributed ledger. The platform 101 will change the ownership of the intellectual property right from the seller to the buyer upon payment confirmation. Hence, the intellectual property right is released for the buyer to put into the market. The whole process in this distributed ledger is witnessed by all the corresponding parties. The completion 105 of the trade information transaction depends on the necessity of registration in the corresponding intellectual property office. An electronic official form is prepared automatically by the platform 101 if the trade information transaction require registration. Human or system will verify the content of the official form and the platform 101 or agent will submit the official form to relevant authorities office.

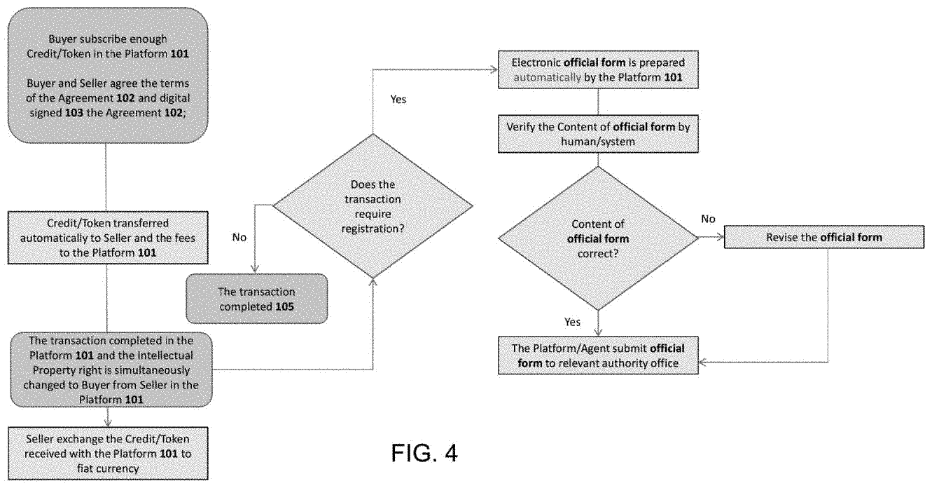

An agreement between buyer and seller with token payment is shown in FIG. 4. The buyer must subscribe enough credit or token on the platform 101 in order to complete 105 the transaction. The customized digital agreement 102 between buyer and seller is uploaded to the platform 101 in the distributed ledger in accordance with the terms of sales and purchases or license agreement. Every corresponding parties could view the same customized digital agreement 102 whereby the buyer and seller can negotiate the terms in the customized digital agreement 102 via on line or offline. The buyer will transfer the token consideration to the seller simultaneously once both buyer and seller digitally sign 103 the customized digital agreement 102 and uploaded the signed customized digital agreement 102 to the distributed ledger. The platform 101 will change the ownership of the intellectual property right from the seller to the buyer upon payment confirmation. Hence, the intellectual property right is released for buyer to put into the market. Seller exchange the credit or token received with the platform 101 to fiat currency. The whole process in this distributed ledger is witnessed by all the corresponding parties. The completion 105 of the trade information transaction depends on the necessity of registration in the corresponding intellectual property office. An electronic official form is prepared automatically by the platform 101 if the trade information transaction require registration. Human or system will verify the content of the official form and the platform 101 or agent will submit the official form to relevant authorities office.

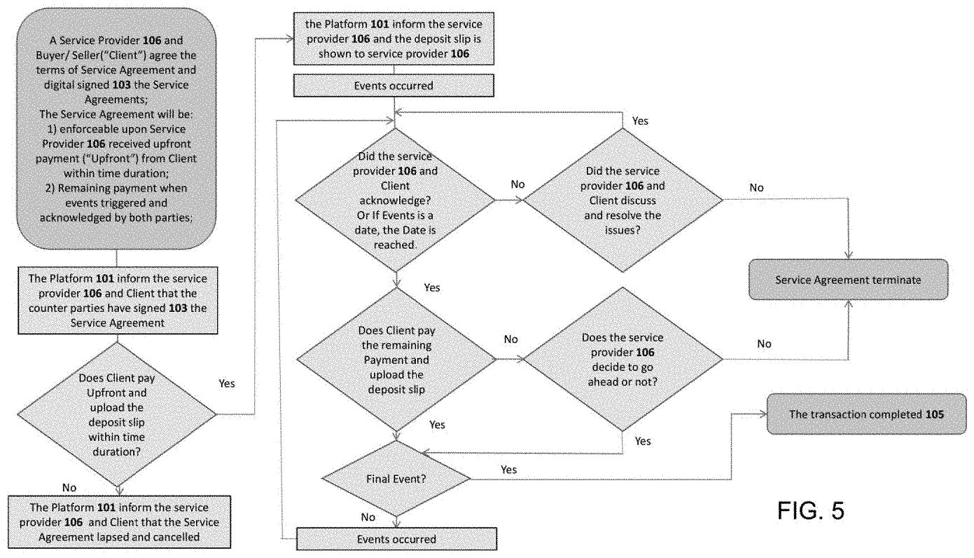

Referring to FIG. 5, an agreement between service provider 106 and client of buyer or seller with offline payment is shown. The customized digital agreement 102 between the service provider 106 and client of buyer or seller is uploaded to the platform 101 in the distributed ledger in accordance with the terms of sales and purchases or license agreement. Every corresponding parties could view the same customized digital agreement 102 whereby the respective parties can negotiate the terms in the customized digital agreement 102 via on line or offline. The client of buyer or seller has to make first upfront payment in a time duration and upload the proof of payment in the distributed ledger once both service provider 106 and client of buyer and seller digitally sign 103 the service agreement and uploaded the signed service agreement to the distributed ledger. The platform 101 will cancel the transaction if the client of buyer or seller fails to make the payment within the time duration. A serial of events will be triggered one by one upon service provider 106 confirmed the upfront payment from client in the time duration. Said events may refer to any traceable events such as approval by an authority, consent message of satisfaction work done and etcetera. The result will be uploaded to the distributed ledger and the client of buyer or seller need to pay balance payment once the said event completed. The next event will be processed until final event occurs upon service provider 106 confirmed the balance payment for said event. The transaction is considered completed 105 when final event occurred.

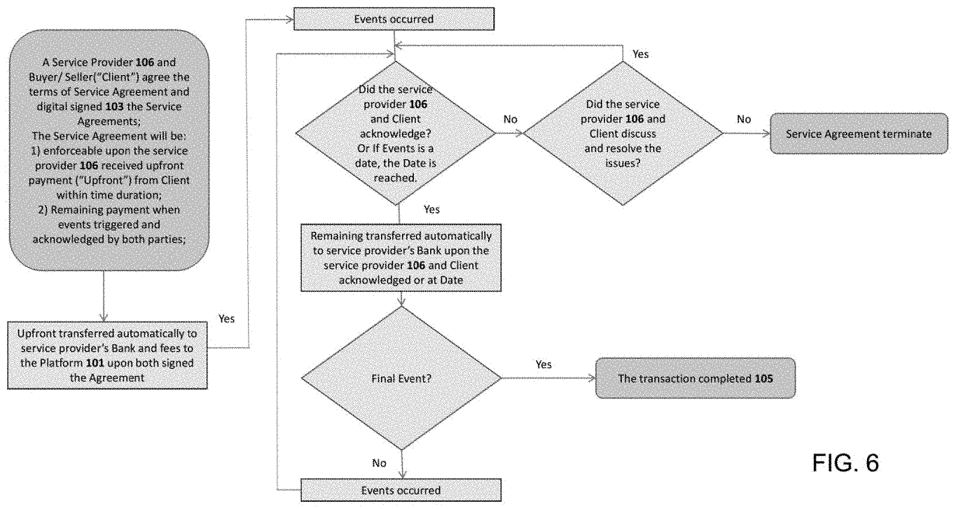

An agreement between service provider 106 and client of buyer or seller with online payment is shown in FIG. 6. The customized digital agreement 102 between the service provider 106 and client of buyer or seller is uploaded to the platform 101 in the distributed ledger in accordance with the terms of sales and purchases or license agreement. Every corresponding parties could view the same customized digital agreement 102 whereby the respective parties can negotiate the terms in the customized digital agreement 102 via on line or offline. The client's bank will transfer first upfront payment consideration to the seller's bank simultaneously once both service provider 106 and client of buyer or seller digitally sign 103 the service agreement and uploaded the signed service agreement to the distributed ledger. A serial of events will be triggered one by one upon service provider 106 confirmed the first upfront payment from client of buyer or seller in the time duration. Said events may refer to any traceable events such as approval by an authority, consent message of satisfaction work done and etcetera. The result will be uploaded to the distributed ledger and the client's bank will transfer the balance consideration to the seller's bank simultaneously once the event completed. The next event will be processed until final event occur upon service provider 106 confirmed the balanced consideration payment for the event.

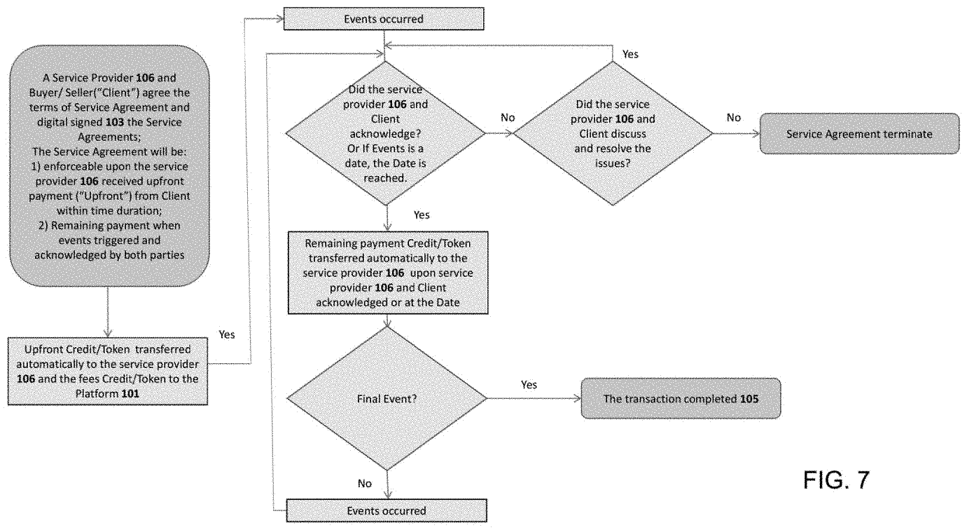

Referring to FIG. 7, an agreement between service provider 106 and client of buyer or seller with token payment is shown. The client must subscribe enough credit or token in the platform 101 in order to complete 105 the transaction. The customized digital agreement 102 between the service provider 106 and client of buyer or seller is uploaded to the platform 101 in the distributed ledger in accordance with the terms of sales and purchases or license agreement. Every corresponding parties could view the same agreement whereby the respective parties can negotiate the terms in the customized digital agreement 102 via on line or offline. The client's bank will transfer the token equivalent upfront to the seller's bank simultaneously once both service provider 106 and client digitally sign 103 the service agreement and uploaded the signed service agreement to the distributed ledger. The result will be uploaded to the distributed ledger and the client's bank will transfer balance tokens equivalent of the consideration to the seller's bank simultaneously once the event completed. The next event will be processed until final event occurs upon service provider 106 confirmed the balance payment for the event. The seller exchanges the token received with platform 101 to fiat currency anytime.

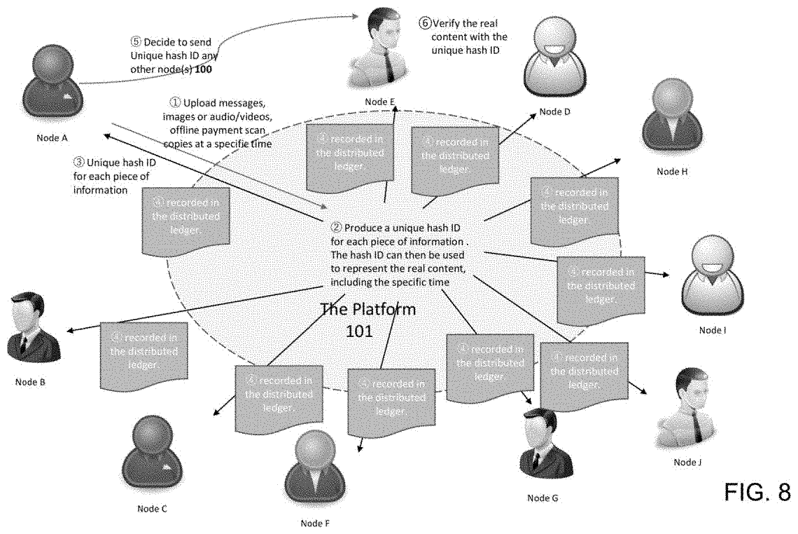

FIG. 8 shows a diagram of time stamp and providing hash ID for uploading information and/or document. According to FIG. 8, Node A may upload information included but not limited messages, images, audios, videos or offline payment scan copies at a specific time to the platform 101. A unique hash ID for each piece of information is produced wherein the hash ID can be used to represent the real content, including the specific time for uploading the information. The unique hash ID for each piece of information is sent back to Node A. Each hash ID is recorded in the distributed ledger to corresponding nodes such as Node B, Node C, Node D, Node E, Node F, Node G, Node H, Node I and Node J. Node A may decide to send the produced unique hash ID to any other node(s). Everyone can easily verify the real content with the hash ID.

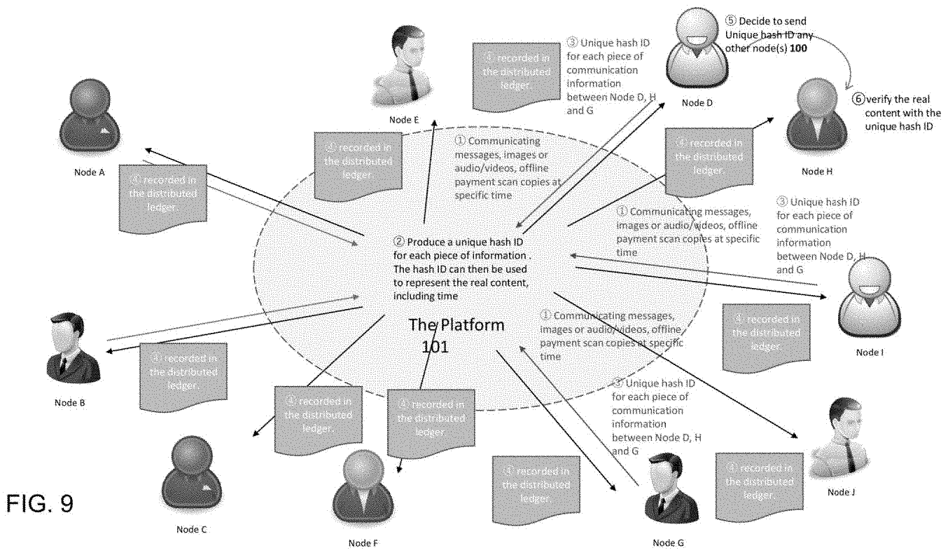

FIG. 9 shows a diagram of time stamp and providing hash ID for communicating content on the platform 101. Users such as Node D, Node I and Node G communicate information such as messages, images, audios, videos or offline payment scan copies at a specific time to the platform 101. A unique hash ID for each piece of information is produced. The hash ID is used to represent the real content including the specific time for uploading the information. The produced hash ID can be used in between Node D, I and G. The each hash ID is recorded in the distributed ledger to corresponding nodes such as Node A, Node B, Node C, Node D, Node E, Node F, Node G, Node H, Node I and Node J. Node D may decide to send the produced unique hash ID to any other node(s). Everyone can easily verify the real content with the hash ID.

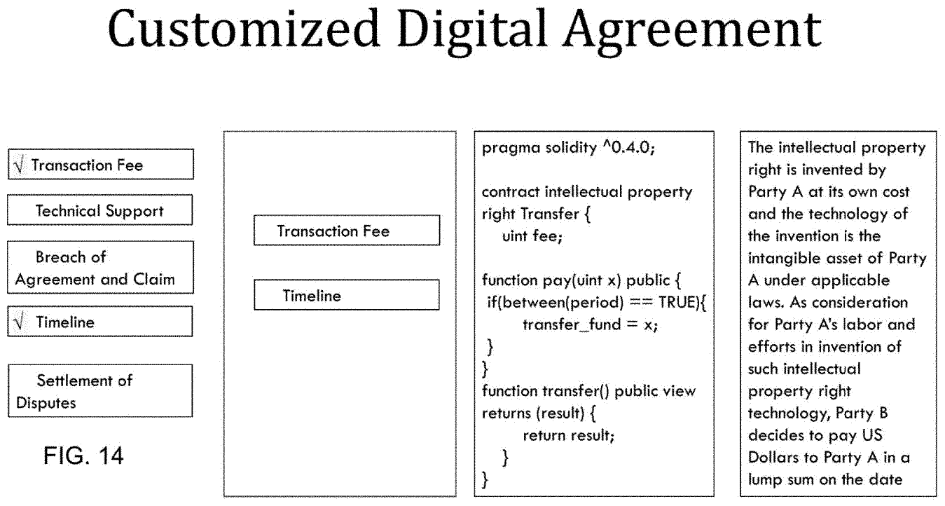

Referring to FIG. 14, a diagram of customized digital agreement 102 is shown. A module is created to deal with different kind of legal contract whereby both buyers and sellers can use a drop-down menu to select existing items which have already been fully reviewed by service node 100f and customize the legal terms. The users may only need to fill in basic information such as name, time, amount of fund and etcetera. For example, user of Party B in FIG. 14 may select transaction fee and timeline. As such Party B may pay to Party A in a lump sum on a specific date.

FIG. 15 shows a diagram example of customized digital agreement 102 in between Node IPN and Node PN. The Node IPN which is intellectual property seller and the Node PN is buyer whereby both can negotiate the terms of sales and purchase agreement on the platform 101, and choose the corresponding clauses from the modular clauses list to compose a customized digital agreement 102. Referring to FIG. 15, users could select clause D (payment schedule) and choose the prefer payment module clauses. As such, the customized digital agreement 102 comprises a clause A1, a clause B3, a clause C6, a clause D3 and etcetera in according to selection of both Node IPN and Node PN.

The method and system for time stamping and transferring intellectual property right in present invention is a customized digital module agreement 102. Each step of the trade transaction is recorded in a distributed manner for ensuring corresponding parties able to trace and check the records. Said records would have a strong time stamp proof and serve as a strong legal evidence upon infringement and disputes of intellectual property right occur.

A synchronization mechanism will function so that each node 100 in the platform 101 can update the transaction to its distributed ledger for maintaining multiple backups of the intellectual property exchange trading ledger in the platform 101. Therefore, its advantage of distributed storage is that single point of failure could be avoided. Any node 100 in the platform 101 can take advantage of the synchronization mechanism to easily obtain information from other nodes 100 that they have not received during temporary offline. Therefore, the content that directly or indirectly stored in the distributed intellectual property exchange trading ledger is ensured to be open, complete, consistent and temper-proof.

Although the present invention has been described with reference to specific embodiments, also shown in the appended figures, it will be apparent for those skilled in the art that many variations and modifications can be done within the scope of the invention as described in the specification and defined in the following claims.

We claim:

1. A computer implemented method for intellectual property time stamp and right transfer, comprising:
enrolling a plurality of corresponding nodes to a platform;
wherein the corresponding nodes comprise an administration node, a public node, a super node, a child node, an independent individual professor node and a service node;
uploading information and document of the corresponding intellectual property right to the platform by the independent individual professor node, the super node or the child node;
wherein time stamping the information and/or document upon uploaded to the platform;
searching relevant intellectual property right on the platform;
negotiating on the platform;
composing a customized digital agreement on the platform by selecting, amending and/or adding on a relevant module clause;
wherein the customized digital agreement comprises smart contract functions for automating execution;
signing the agreed agreement digitally by respective corresponding parties;
blocking the target intellectual property right automatically for further selling; and
completing the trade information transaction upon receiving full payment.

2. The computer implemented method for intellectual property time stamp and right transfer according to claim 1, wherein the intellectual property right comprises a patent, a trademark, a trade secret, an industrial design, a copyright and a geographical indication.

3. The computer implemented method for intellectual property time stamp and right transfer according to claim 1, wherein the administration node comprises an administrator, the public node comprises a buyer, the super node comprises an university and research institute, the service node comprises a service provider, the child node and the independent individual professor node comprises an inventor.

4. The computer implemented method for intellectual property time stamp and right transfer according to claim 1, wherein the content of the uploaded information, document and negotiation that involve any communications by nodes is stored in a distributed ledger based on hash table mapping approach.

5. The computer implemented method for intellectual property time stamp and right transfer according to claim 4, wherein each piece of stored information in the distributed ledger comprises a hash ID.

6. The computer implemented method for intellectual property time stamp and right transfer according to claim 1, wherein the information and document include but not limited to writing, audio and video.

7. The computer implemented method for intellectual property time stamp and right transfer according to claim 1, wherein the module clause comprises plurality of selection for respective parties to select, amend and/or add.

8. The computer implemented method for intellectual property time stamp and right transfer according to claim 1, wherein the respective parties are optional to engage a service provider for providing services including but not limited to marketing the patent, legal advices, valuation and writing descriptions.

9. The computer implemented method for intellectual property time stamp and right transfer according to claim 8, wherein the service provider includes but not limited to legal advisors, intellectual property valuers, writers, promoters, marketers, intellectual property agents, and other intellectual property services.

10. The computer implemented method for intellectual property time stamp and right transfer according to claim 1, wherein the signing of the customized digital agreement comprises one intellectual property holder with one buyer, one intellectual property holder with multiple buyers, a multiple intellectual property holders with one buyer; a multiple intellectual property holders with multiple buyers; a service provider with client or buyer or seller and in between the service providers.

11. The computer implemented method for intellectual property time stamp and right transfer according to claim 1, wherein the smart contract functions is triggered fund transfer or other actions automatically after signage of the agreed agreement.

12. The computer implemented method for intellectual property time stamp and right transfer according to claim 11, wherein the other actions comprise an issue of call option for another intellectual property rights, executing another digital agreement and the like.

13. The computer implemented method for intellectual property time stamp and right transfer according to claim 1, wherein the trade information transaction is change of intellectual property ownership.

14. The computer implemented method for intellectual property time stamp and right transfer according to claim 1, wherein the completion of the trade information transaction depends on the necessity of registration in the corresponding intellectual property office.

15. The computer implemented method for intellectual property time stamp and right transfer according to claim 1, wherein the payment comprises an offline payment, an online payment and a token payment.

16. A system of customized digital agreement for intellectual property time stamp and right transfer, comprising:
means for selecting, amending and/or adding on a relevant module clause; and
means for automating execution using smart contract functions.

17. The system of customized digital agreement for intellectual property time stamp and right transfer according to claim 16, wherein the module clause comprises plurality of selection for respective parties to select, amend and/or add.

18. The system of customized digital agreement for intellectual property time stamp and right transfer according to claim 16, wherein the smart contract functions is configured to trigger fund transfer or other actions automatically after signage of the agreed agreement.

19. The system of customized digital agreement for intellectual property time stamp and right transfer according to claim 18, wherein the other actions comprise an issue of call option for another intellectual property rights, executing another digital agreement and the like.
